(19) United States
(12) Patent Application Publication
(10) Pub. No.: US 2012/0016825 A1
(43) Pub. Date: Jan. 19, 2012

(54) DETECTOR CONFIGURATION APPARATUS, METHOD, AND PROGRAM

(76) Inventors: Hirokazu KAMEYAMA, Kanagawa-ken (JP); Kouji YAMAGUCHI, Kanagawa-ken (JP)

(21) Appl. No.: 13/184,261

(22) Filed: Jul. 15, 2011

(30) Foreign Application Priority Data
Jul. 15, 2010 (JP) 160186/2010

(51) Int. Cl. G06F 15/18; G06N 5/02

(52) U.S. Cl. 706/12; 706/46

(57) ABSTRACT

A detector configuration apparatus for configuring a detector that performs detection through a plurality of detection stages with different resolutions capable of objectively determining a detection target modality type to be detected in each stage. The detector is configured to detect to which of a plurality of attribute values an attribute of an object included in input data corresponds with respect to each of a plurality of modality types. A variation amount calculation unit obtains, based on a plurality of teacher data corresponding to each modality type used for training the detector, a representative value of variation between a plurality of teacher data with respect to each modality type, and a detection stage determination unit determines in which stage of the plurality of detection stages each modality type is to be detected based on the representative value of variation between the teacher data.

### BACKGROUND OF THE INVENTION

1. Field of the Invention

The present invention relates generally to a detector configuration apparatus, method, and program and more specifically to a detector configuration apparatus and method for configuring a detector for detecting a state or attribute of an object based on teacher data used for training the detector. The invention also relates to a computer readable recording medium on which is recorded a program for causing a computer to perform the method.

2. Description of the Related Art

Object detection techniques for detecting an object, such as a human face, from an input image are known. In the field of object detection, techniques for detecting an object using a plurality of images having different resolutions (image sizes) are also known. Japanese Unexamined Patent Publication No. 2007-265390 is a document that describes object detection using images in a plurality of stages (paragraphs [0022], [0023], and [0119] to [0135]). In Japanese Unexamined Patent Publication No. 2007-265390, one or more reduced images are generated from an input image by performing reduction processing on the input image at predetermined reduction ratios. The generated one or more images and the input image form hierarchical images. In Japanese Unexamined Patent Publication No. 2007-265390, edge feature images are generated in four directions with respect to each hierarchical image and face detection is performed using each edge feature image and a weight table used for face detection. The weight table is obtained from teacher samples (face sample images and non-face sample images) used for training and stored in a memory in advance.

Japanese Unexamined Patent Publication No. 2007-265390 also describes that, when performing face detection on an upper hierarchical image having a large size, coarse detection is performed as pre-processing using a lower hierarchical image having a smaller total number of pixels than that of the upper hierarchical image. Here, for example, an input image is assumed to be the upper hierarchical image and a reduced image obtained by reducing the input image into a half is assumed to be the lower hierarchical image. As pre-processing of face detection on the input image, coarse face detection is performed using the reduced image having a smaller size and face detection is performed on the input image only when a face is detected by the coarse face detection. Japanese Unexamined Patent Publication No. 2007-265390 describes that, in this way, face detection on an upper hierarchical image may be omitted when no face is detected by the coarse detection and faster processing may be achieved.

For example, where a plurality of types of states or attributes is detected for an object, it is conceivable that all of the plurality of types of states or attributes is detected in two-stage processing of coarse and fine detection. It is not always the case, however, that all of the detection target states or attributes are detected meaningfully by the coarse detection. In the design of detectors, designers subjectively determine as to which types of states or attributes are to be detected by coarse detection based on their experience and intuition. Consequently, detectors have different configurations depending on the designers and efficient detection is not always performed. Heretofore, no method has been known for objectively determining in which stage of a plurality of stages, from coarse detection to fine detection, a plurality of types of states or attributes is to be detected.

In view of the circumstances described above, it is an object of the present invention to provide, when configuring a detector that performs detection through a plurality of stages of different resolutions, a detector configuration apparatus and method capable of objectively determining the type of a state or an attribute to be detected in each stage. It is a further object of the present invention to provide a computer readable recording medium on which is recorded a program for causing a computer to perform the method.

### SUMMARY OF THE INVENTION

In order to solve the problem described above, the present invention provides a detector configuration apparatus, including

a variation amount calculation unit for obtaining, based on a plurality of teacher data corresponding to each of a plurality of modality types, a representative value of variation between the plurality of teacher data with respect to each modality type, the teacher data being used for training a detector that detects, through a plurality of detection stages with different resolutions, to which of a plurality of attribute values an attribute of an object included in input data corresponds with respect to each of a plurality of modality types; and

a detection stage determination unit for determining in which stage of the plurality of detection stages each modality type is to be detected based on the representative value of variation between the teacher data obtained by the variation amount calculation unit.

The term “modality type” as used herein refers to a type of state or attribute of a detection target object, and the term “variation between teacher data” as used herein refers to a value representing a degree of variation between the teacher data. The term “representative value of variation” as used herein refers to a value representing the degree of variation. The representative value of variation may be set such that the greater the degree of variation the greater the representative value or the greater the degree of variation the smaller the representative value.

The variation amount calculation unit may be a unit that obtains a variation between a plurality of teacher data corresponding to each attribute to be detected in each modality type, and obtains the representative value of variation for each modality type based on the obtained variation between the teacher data corresponding to each attribute.

The variation amount calculation unit may include an inter-data variation calculation unit for obtaining a variation between a plurality of teacher data corresponding to each attribute value, and a representative value determination unit for determining the representative value of variation based on the variation between the teacher data corresponding to each attribute value obtained by the inter-data variation calculation unit.

In this case, the representative value determination unit may be a unit that obtains an average value of the variation between the teacher data corresponding to each attribute value and determines the obtained average value to be the representative value of variation.

The inter-data variation calculation unit may be a unit that obtains, with respect to a plurality of dimension positions, a data distribution of elements of each of the plurality of teacher data at the same dimension position when the teacher data are viewed as vector data, obtains a data variation for each dimension position based on the obtained data distribution, and obtains the variation between the teacher data based on the data variation obtained for each dimension position.

The inter-data variation calculation unit may be a unit that determines a variation of data variation obtained for each dimension position as the variation of the teacher data corresponding to the attribute value.

The inter-data variation calculation unit may be a unit that converts resolution of the plurality of teacher data to resolution corresponding to each of the plurality of detection stages and obtains, for each detection stage, a data distribution of vector data at the same dimension position representing each of the teacher data having converted resolution corresponding to each detection stage.

The inter-data variation calculation unit may be a unit that obtains, for each detection stage, a variation between the teacher data corresponding to each attribute value, and the representative value determination unit may be a unit that determines a representative value of variation for each detection stage based on the variation between the teacher data corresponding to each attribute value with respect to each detection stage obtained by the inter-data variation calculation unit.

In this case, the detection stage determination unit may be a unit that compares a threshold value set to each detection stage with the representative value of variation determined with respect to each modality for each detection stage by the representative value determination unit and determines a modality type having a representative value of variation greater than or equal to a threshold value of a certain one of the detection stages to be detected in the certain one of the detection stages. If the representative value of variation is set such that the greater the degree of variation the smaller the representative value, a determination may be made that a modality type having a representative value of variation smaller than a threshold value of a certain one of the detection stages to be detected in the certain one of the detection stages.

The inter-data variation calculation unit may be a unit that obtains the data distribution at the same dimension position after converting dimensionalities of vector data representing the plurality of teacher data to a predetermined dimensionality.

The detection stage determination unit may be a unit that determines any of the plurality of modality types having a representative value of variation determined by the representative value determination unit greater than or equal to a threshold value Th (1) set to a first stage when the plurality of detection stages is arranged in ascending order of resolution to be detected in the first detection stage onward and any of the plurality of modality types having a representative value of variation determined by the representative value determination unit greater than or equal to a threshold value Th(i+1)(i is an integer in the range from 1 to the number of stages minus 1) set to (i+1)^{th} stage and smaller than a threshold value Th(i) set to i^{th} stage to be detected in the (i+1)^{th} stage onward.

The detection stage determination unit may be a unit that compares a representative value of variation of teacher data corresponding to a modality type determined to be detected in a certain detection stage with a predetermined threshold value and excludes the modality type from a detection target list for a detection stage having higher resolution than that of the certain detection stage when the representative value of variation of teacher data is greater than or equal to the predetermined threshold value.

The detection stage determination unit may be a unit that, when a determination is made that a plurality of modality types is to be detected in one detection stage, obtains a correlation between teacher data corresponding to the plurality of modality types to be detected in the one detection stage and, when the obtained correlation is greater than or equal to a predetermined threshold value, determines that the plurality of modalities to be detected in the one detection stage is to be detected in series.

The term “correlation” as used herein refers to a value representing how well the data resemble. As for the correlation, correlation coefficient, cross-correlation function, or the like may be used.

In the aforementioned case, the detection stage determination unit may be a unit that obtains, with respect to each of the plurality of modality types to be detected in the one detection stage, a representative value of teacher data from a plurality of teacher data corresponding to each attribute value, combines attribute values of a plurality of modality types, obtains a correlation between representative values of teacher data corresponding to the combined attribute values, obtains a representative value of correlations obtained with respect to each combination of attributes, and determines the obtained representative correlation value as the correlation between teacher data corresponding to the plurality of modality types.

The detector configuration apparatus of the present invention may further include a detection matrix generation unit for generating a detection matrix with respect to each modality based on the teacher data.

The invention also provides a detector configuration method which is a method for configuring a detector that detects, through a plurality of detection stages with different resolutions, to which of a plurality of attribute values an attribute of an object included in input data corresponds with respect to each of a plurality of modality types, the method including the steps of:
obtaining, based on a plurality of teacher data corresponding to each modality type used for training the detector, a representative value of variation between the plurality of teacher data with respect to each modality type; and
determining in which stage of the plurality of detection stages each modality type is to be detected based on the obtained representative value of variation between the teacher data.

The invention further provides a computer readable recording medium on which is recorded a program for causing a computer to perform processing for configuring a detector that detects, through a plurality of detection stages with different resolutions, to which of a plurality of attribute values an attribute of an object included in input data corresponds with respect to each of a plurality of modality types, the program causing a computer to perform the steps of:
obtaining, based on a plurality of teacher data corresponding to each modality type used for training the detector, a representative value of variation between the plurality of teacher data with respect to each modality type; and
determining in which stage of the plurality of detection stages each modality type is to be detected based on the obtained representative value of variation between the teacher data.

According to the detector configuration apparatus, method, and computer readable recording medium of the present invention, a representative value of variation between a plurality of teacher data is obtained with respect to each modality type and a determination is made as to in which stage of a plurality of detection stages each modality type is to be detected based on the obtained representative value of variation between the teacher data. The present invention may appropriately determine which modality is to be detected in which stage based on the variation between teacher data. Further, a modality type to be detected in each stage may be determined objectively based on the variation between teacher data.

### BRIEF DESCRIPTION OF THE DRAWINGS

FIG. 1 is a block diagram of a detector configuration apparatus according to a first embodiment of the present invention.

FIG. 2 illustrates a detector configured by the detector configuration apparatus.

FIG. 3 illustrates conversion of teacher data to a reference size.

FIG. 4 is a graph illustrating pixel value distributions.

FIG. 5 is a flowchart illustrating an operating procedure.

FIG. 6 illustrates calculation of correlation between teacher data.

FIG. 7 is a block diagram of a detector illustrating an example configuration.

### DESCRIPTION OF THE PREFERRED EMBODIMENTS

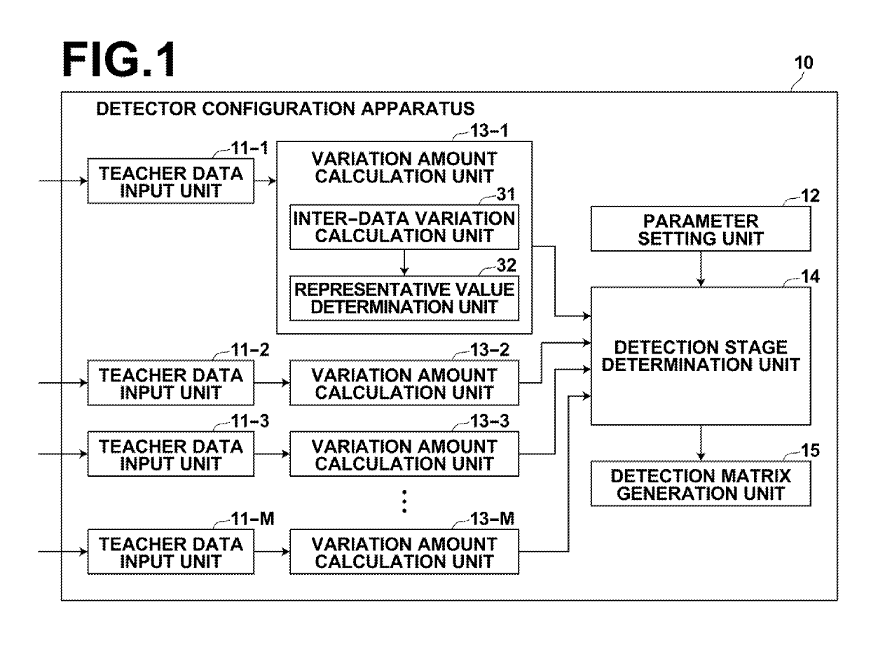

Hereinafter, embodiments of the present invention will be described in detail with reference to the accompanying drawings. FIG. 1 illustrates a detector configuration apparatus according to a first embodiment of the present invention. Detector configuration apparatus 10 includes teacher data input unit 11, parameter setting unit 12, variation amount calculation unit 13, detection stage determination unit 14, and detection matrix generation unit 15. Detector configuration apparatus 10 is an apparatus for determining the configuration of a detector that detects a detection target state or attribute of an object (also, called as “detection target modality”) included in input data. The function of each unit may be realized by causing a computer to perform processing according to a predetermined program. Alternatively, the function of each unit may be realized by an IC (Integrated Circuit).

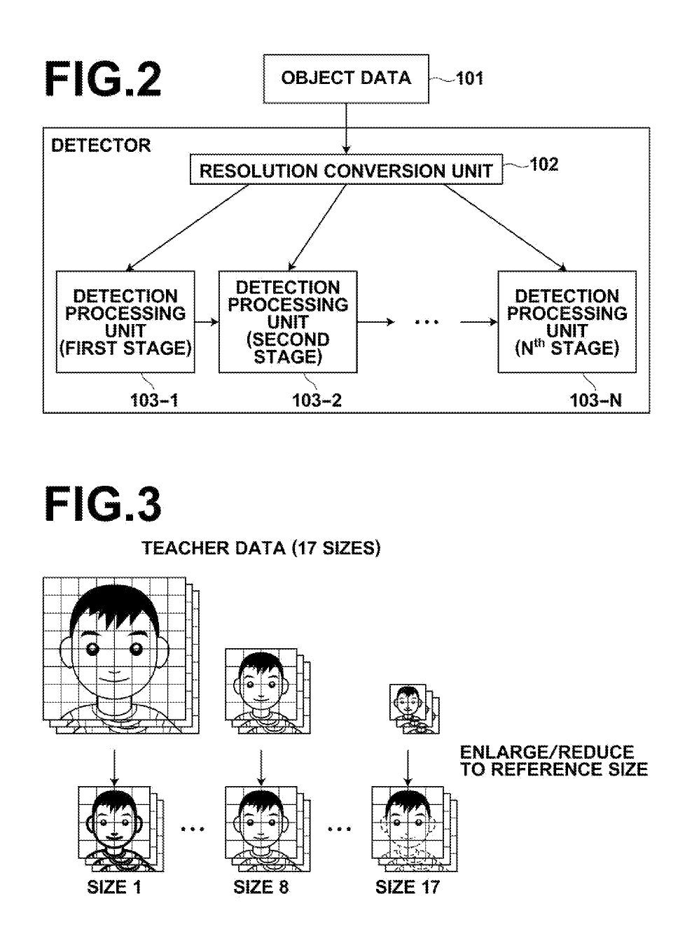

FIG. 2 illustrates a detector configured by detector configuration apparatus 10. Detector 100 receives object data 101 that includes an object. For example, detector 100 receives image data representing an object detected from image data as object data 101. With object data 101 as input, detector 100 detects, with respect to each of a plurality of types of modalities, to which of a plurality of attribute values the attribute of an object included in object data 101 corresponds.

Detector 100 includes N-stage (N is an integer of two or greater) detection processing units from the first to N^{th} stages 103-1, 103-2, - - - , 103-N and detects an attribute value of each of a plurality of modality types through detection processing in a plurality of detection stages in which resolutions are different from each other. Object data 101 is inputted to detection processing unit 103 in each stage via resolution conversion unit 102. It is assumed here that the resolution of object data 101 received by first detection processing unit 103-1 is lowest, that received by the second detection processing unit 103-2 is second lowest, that received by the third detection processing unit 103-3 is third lowest, and so on, and the resolution at N^{th} detection processing unit 103-N is highest. For example, resolution conversion unit 102 reduces or enlarges the size of the image which is object data 101 according to the resolution of detection processing unit 103 in each stage.

Detector configuration apparatus 10 shown in FIG. 1 determines which modality type is to be detected by detection processing unit 103 in each stage of detector 100. Detector configuration apparatus 10 also generates a detection matrix used for attribute detection with respect to the detection target modality type in each stage.

Teacher data input unit 11 inputs a plurality of learning data (teacher data) corresponding to detection target modality type. Variation amount calculation unit 13 obtains a variation between a plurality of teacher data inputted by teacher data input unit 11. When the number of modality types to be detected by detector 100 is M (integer of two or greater), detector configuration apparatus 10 may include M teacher data input units 11-1 to 11-M. Further, detector configuration apparatus 10 may include M variation amount calculation units 13-1 to 13-M corresponding to the detection target modality types.

Each teacher data input unit 11 inputs a plurality of teacher data with respect to each attribute value to be detected for the corresponding modality type. Now, for example, considering the case in which the object is a face detected from an image, the modality type is face size, and detector 100 is going to determine to which of 17 different face sizes from 1 to 17 the size of the face in object data 101 corresponds. In this case, teacher data input unit 103 corresponding to the modality type “face size” receives, for example, 100 teacher data with respect to each of 17 face sizes.

Parameter setting unit 12 sets the number of detection stages and data resolution of detection processing in each stage of detector 100 to be configured. Variation amount calculation unit 13 obtains a representative value of variation between a plurality of teacher data with respect to each modality type based on the teacher data. For example, variation amount calculation unit 13 corresponding to the modality type “face size” calculates a variation between a plurality of teacher data used for learning “face size” based on teacher data inputted from teacher data input unit 11 corresponding to the modality type “face size” and obtains a representative value of variation based on the calculated variation.

Variation amount calculation unit 13 obtains a variation between a plurality of teacher data with respect to each attribute value to be detected in the corresponding modality type. Then, variation amount calculation unit 13 obtains a representative value of variation based on the variation between the teacher data corresponding to each attribute value. For example, with respect to the modality type “face size”, variation amount calculation unit 13 obtains a variation between a plurality of teacher data corresponding to each of 17 different face sizes, and determines an average value of the obtained 17 variations between the teacher data as the representative value of variation corresponding to the modality type “face size”.

Detection stage determination unit 14 determines in which stage of a plurality of detection stages of the detector each modality type is to be detected based on the representative value of variation between the teacher data of each modality type obtained by variation amount calculation units 13-1 to 13-M. That is, detection stage determination unit 14 determines which modality type of M different modality types is to be detected by which of the first to N^{th} detection processing units 103 (FIG. 2). Detection stage determination unit 14 receives a threshold value for each detection stage from parameter setting unit 12 and compares the representative value of variation of each modality type with each threshold value to determine which modality type should be detected in which stage.

Detection matrix generation unit 15 receives information indicating which modality type is to be detected in which stage from detection stage determination unit 14. With respect to each modality type, detection matrix generation unit 15 generates a detection matrix based on the corresponding teacher data. Generation of the detection matrix corresponds to the training of the detector using the teacher data. Generally, processing performed by detection matrix generation unit 15 includes generation of real pixel space to feature space conversion matrix U₁, generation of real individual space to feature space conversion matrix U₂, and calculation of pixel to individual difference feature space conversion matrix Σ₁₂. Detection matrix generation unit 15 generates the matrices after adjusting the resolution to that at the time of teacher data detection.

Variation amount calculation unit 13 includes inter-data variation calculation unit 31 and representative value determination unit 32. Although inter-data variation calculation unit 31 and representative value determination unit 32 are indicated only in variation amount calculation unit 13-1 in FIG. 1, each of the other variation amount calculation units 13-2 to 13-M also includes inter-data variation calculation unit 31 and representative value determination unit 32.

Inter-data variation calculation unit 31 calculates a variation between a plurality of teacher data. Inter-data variation calculation unit 31 calculates a variation between a plurality of teacher data with respect to each attribute value of detection target modality type. The variation between data may be, for example, variance or standard deviation. For example, inter-data variation calculation unit 31 obtains a variation between 100 teacher data inputted in response to “size 1” with respect to the modality type “face size” as the variation between teacher data corresponding to “size 1”. Likewise, inter-data variation calculation unit 31 obtains variations between teacher data for the remaining 16 modality types.

Inter-data variation calculation unit 31 obtains a data distribution of elements of each of a plurality of teacher data at the same dimension position when the teacher data are viewed as vector data. For example, where the teacher data are image data arranged two-dimensionally, inter-data variation calculation unit 31 obtains a pixel value distribution of a plurality of image data in the same coordinates. Inter-data variation calculation unit 31 obtains data distributions of elements of vector data representing the teacher data at a plurality of dimension positions. For example, if the teacher data are image data of 16×16 size, inter-data variation calculation unit 31 obtains a data distribution of pixel values with respect to each of 256 coordinate positions.

Inter-data variation calculation unit 31 obtains a data variation with respect to each dimension position based on the obtained data distribution. With respect to, for example, coordinate position (0, 0), inter-data variation calculation unit 31 calculates the variance of pixel values of a plurality of teacher data at the coordinate position. With respect to each coordinate position at which the data distribution has been obtained, inter-data variation calculation unit 31 obtains a data variation from the obtained data distribution. For example, when a data distribution of pixel values has been obtained for each of 256 coordinate positions, inter-data variation calculation unit 31 calculates the variance of pixel values with respect to each of the 256 coordinate positions.

Based on a data variation obtained with respect to each dimension position, inter-data variation calculation unit 31 obtains a variation between teacher data corresponding to a certain attribute value. Inter-data variation calculation unit 31 obtains, for example, a variation of data variations obtained for a plurality of dimension positions as the variation of the teacher data. When, for example, variance of pixel values of the teacher data at 256 coordinate positions is calculated with respect to the attribute value “size 1” of the modality type “face size”, inter-data variation calculation unit 31 obtains variance of the variance values calculated with respect to the 256 coordinate positions as the variation in the teacher data corresponding to the “size 1”. Alternatively, an average value, mode value, or median value of the variance values calculated with respect to the coordinate positions or the like may be used as the variation corresponding to the “size 1”.

Representative value determination unit 32 determines a representative value of variation between teacher data based on the variation between the data with respect to each attribute value obtained by inter-data variation calculation unit 31. For example, representative value determination unit 32 determines a representative value of variation of modality type “face size” from the variation with respect to each of 17 different face sizes obtained by inter-data variation calculation unit 31. The representative value of variation may be an average value of variations in the data obtained by inter-data variation calculation unit 31 with respect to each attribute value. That is, an average value of variations in the teacher data with respect to each attribute value may be obtained by representative value determination unit 32 and the obtained average value may be used as the representative value. Otherwise, a value obtained by a certain statistical method may be used as the representative value.

When obtaining a data distribution of elements of a plurality of teacher data at the same dimension position, inter-data variation calculation unit 31 converts the resolution of the teacher data to a value corresponding to each of a plurality of detection stages of detector 100 (FIG. 2). For example, if detector has three stages and detection is performed with sizes of 8×8, 16×16, and 32×32 for first, second, and third stages respectively, inter-data variation calculation unit 31 converts the teacher data to three sizes of 8×8, 16×16, and 32×32. Inter-data variation calculation unit 31 obtains a data distribution of the teacher data at the same coordinate position converted to a size corresponding to each of the first to third stages.

With respect to each detection stage, inter-data variation calculation unit 31 obtains a variation in the teacher data corresponding to each attribute value based on the data distribution at each coordinate position obtained from the teach data converted to the resolution corresponding to each detection stage. With respect to, for example, attribute “size 1”, inter-data variation calculation unit 31 obtains a variation in the teacher data for the first stage from the data distribution of the teacher data converted to a size of 8×8 at each coordinate position. Likewise, inter-data variation calculation unit 31 obtains variations in the teacher data for the second and third stages with respect to the attribute “size 1”. Inter-data variation calculation unit 31 also obtains variations in the teacher data for the first, second, and third stages with respect to other attribute values of the modality type “face size” in a manner identical to that described above.

Representative value determination unit 32 determines a representative value of variation of teacher data for each detection stage based on the variation in the teacher data with respect to each attribute in each detection stage obtained by inter-data variation calculation unit 31. For example, representative value determination unit 32 obtains an average value of variations in the teacher data obtained by inter-data variation calculation unit 31 with respect to the respective attributes of the modality “face size” for the first detection stage and determines the obtained average value as the representative value of variation of the teacher data for the first stage with respect to “face size”. For the other stages, representative value determination unit 32 also obtains average values of variations in the teacher data in the same manner as described above and determines the obtained average values as the representative values of variations in the teacher data respectively with respect to “face size”.

Detection stage determination unit 14 compares the representative value of variation determined by representative value determination unit 32 for each detection stage with respect to each modality type with a threshold value set to each detection stage. With respect to, for example, the modality type “face size”, detection stage determination unit 14 compares the representative value of variation of the teacher data determined by representative value determination unit 32 for the first stage with the threshold value set to the first stage. Further, detection stage determination unit 14 compares the representative value of variation of the teacher data for the second stage with the threshold value set to the second stage. Thereafter, detection stage determination unit 14 makes a comparison between the threshold value and representative value of variation by incrementing the stage number. Detection stage determination unit 14 determines a modality type of detection target modality types having a representative value obtained for a stage which is greater than a threshold value set to the stage to be detected at least by the detection processing of the stage.

Here, the threshold value is set to each detection stage such that the higher the resolution in the detection processing the higher the threshold value. That is, a higher threshold value is set to the first stage than that of the second stage, and a higher threshold value is set to the second stage than that of the third stage. If threshold values are set in this way, each modality type is detected such that the higher the variation in the teacher data the modality type has, the lower the resolution of the detection processing in which the modality type is detected. The threshold value set to each stage is not necessarily the same for all modality types. For example, the threshold value for a certain modality type may be different from the threshold value for another modality type.

FIG. 3 illustrates conversion of teacher data to a reference size. Here, human face size is considered as the modality type. It is assumed that the face size has 17 attribute values from size 1 to size 17. It is also assumed that 100 teacher data are inputted to teacher data input unit 11 per attribute value according to each face size. Inter-data variation calculation unit 31 enlarges or reduces 100 teacher data per size to a reference size. Here, the reference size corresponds to a size of each detection stage of detector 100. For example, the reference sizes are set like 8×8 for first stage, 16×16 for second stage, and 32×32 for third stage.

When converting teacher data to a reference size, a reference position may be set between a plurality of teacher data and a predetermined range from the reference position may be trimmed. For example, inter-data variation calculation unit 31 may specify the position of an eye included in each of 100 teacher data of “size 1” and trim a predetermined range from the position. Likewise, for sizes other than “size 1”, a predetermined range from the eye position is trimmed. Inter-data variation calculation unit 31 converts the trimmed teacher data to a reference size. By performing trimming in the manner described above, the face position may be aligned between each of a plurality of teacher data before obtaining a variation.

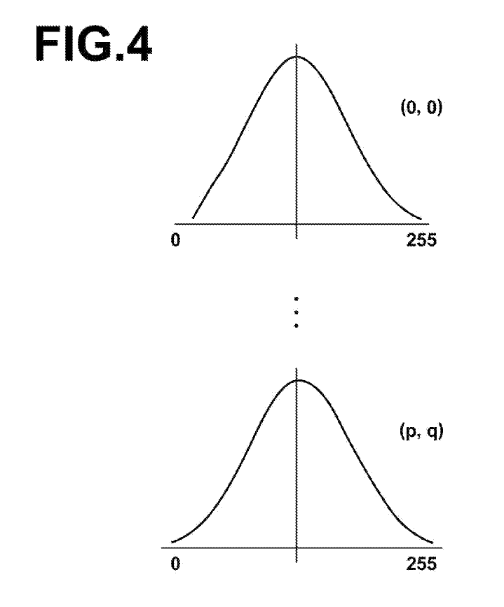

After enlarging or reducing each teacher data to the reference size, inter-data variation calculation unit 31 calculates a variation in the teacher data with respect to each of size 1 to size 17. Here, the reference size is taken as p×q. Inter-data variation calculation unit 31 obtains variance of pixel values of 100 teacher data at p×q coordinate positions per size. FIG. 4 illustrates pixel value distributions. In FIG. 4, the horizontal axis of the graph represents pixel value and the vertical axis represents the frequency of appearance. Each pixel value may take any of values 0 to 255. When a distribution of pixel values is obtained at each coordinate position with respect to 100 teacher data, graphs shown in FIG. 4 are obtained. p×q variance values may be obtained from the distribution of pixel values at each coordinate position.

With respect to, for example, “size 1”, inter-data variation calculation unit 31 obtains variance of p×q variance values obtained with respect to each coordinate position and determines the obtained variance value as the variation between teacher data with respect to “size 1”. For the remaining 16 sizes, inter-data variation calculation unit 31 obtains variance of p×q variance values in the same manner described above and determines each obtained variance value as the variation in the teacher data with respect to each size. Representative value determination unit 32 averages the variance values of 17 sizes obtained by inter-data variation calculation unit 31 and determines the obtained average value as the representative value of variation with respect to the modality type “face size”.

Inter-data variation calculation unit 31 obtains a variation in the teacher data with respect to each attribute value by changing the reference size, and representative value determination unit 32 determines a representative value of variation of the teacher data with respect to “face size” according to each detection stage of detector 100 (FIG. 2). For example, when detector 100 has three detection stages (N=3), representative value determination unit 32 determines a representative value of variation of the teacher data with respect to “face size” for first stage, a representative value of variation of the teacher data with respect to “face size” for second stage, and a representative value of variation of the teacher data with respect to “face size” for third stage.

Detection stage determination unit 14 compares the representative value of variation of the teacher data in “face size” for first stage with a threshold value Th(1) set to the first stage. If the representative value of variation of the teacher data with respect to “face size” for first stage is greater than or equal to the threshold value Th(1) set to the first stage, detection stage determination unit 14 determines that the modality type “face size” is to be detected by the first stage detection processing unit 103-1 (FIG. 2). Further, if the representative value of variation of the teacher data with respect to “face size” for second stage is greater than or equal to the threshold value Th(2) set to the second stage, detection stage determination unit 14 determines that the modality type “face size” is to be detected by the second stage detection processing unit 103-2 (FIG. 2).

Detection stage determination unit 14 performs comparison between the threshold value and representative value of variation until the stage number of the detection processing unit 103 reaches the final stage, and determines which detection processing unit 103 of detector 100 is to detect the “face size”. If a determination is made that a certain modality type is to be detected by a certain stage of detection processing unit 103, detection stage determination unit 14 may determined that the modality type is to be detected by a stage with higher resolution than that of the certain stage without making a comparison between the threshold value and representative value of variation. For example, if a determination is made that “face size” is to be detected by second stage detection processing unit 103-2, detection stage determination unit 14 may determine that the “face size” is to be detected by detection processing unit 103 in the third stage onward without making a comparison between the threshold value and representative value of variation with respect to the “face size”.

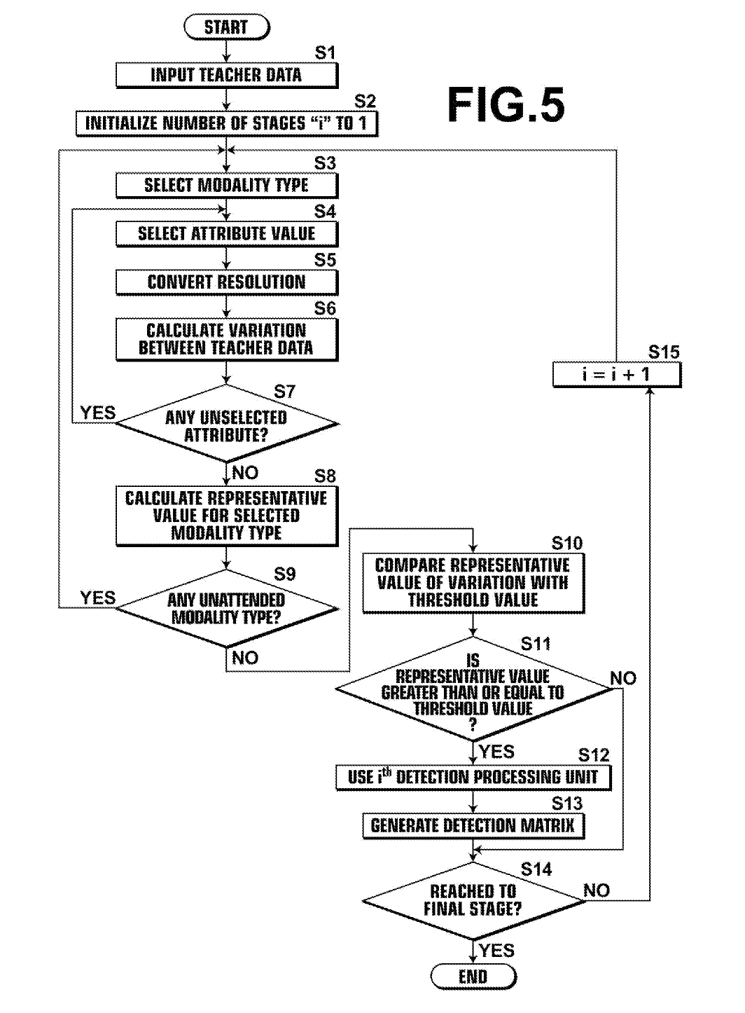

FIG. 5 illustrates operating procedure. Note that information related to the number of detection processing stages of a detector to be configured and resolution of each detection stage is already set in variation amount calculation unit 13 and detection stage determination unit 14. Further, information related to a threshold value for each stage and the like is already set in detection stage determination unit 14 by parameter setting unit 12. Teacher data input unit 11 inputs teacher data (step S1). In step S1, teacher data corresponding to a plurality of modality types may be inputted in parallel or teacher data corresponding to each modality type may be inputted in series.

Variation amount calculation unit 13 initializes a variable “i” representing the number of stages as i=1 (step S2). Variation amount calculation unit 13 selects one of detection target modality types (step S3). Then, variation amount calculation unit 13 selects one of attribute values to be detected in the selected modality type (step S4). Variation amount calculation unit 13 corresponding to the selected modality type converts the resolution of each of a plurality of teacher data corresponding to the selected attribute value to resolution for detection performed by i^{th} stage detection processing unit 103-i (FIG. 2)(step S5). Note that the plurality of teacher data may be trimmed into a predetermined range from the reference position by variation amount calculation unit 13 prior to the resolution conversion.

Variation amount calculation unit 13 obtains a variation between teacher data based on the teacher data converted in resolution in step S5 (step S6). In step S6, inter-data variation calculation unit 31 obtains a data distribution of elements of a plurality of teacher data at the same dimension position when the teacher data are treated as vector data and obtains a data variation with respect to each dimension position based on the obtained data distribution. Inter-data variation calculation unit 31 obtains a variation between teacher data corresponding to the attribute value selected in step S4 based on the variation obtained with respect to each dimension position.

Variation amount calculation unit 13 determines whether or not any unattended attribute value is remaining in the modality type selected in step S3 (step S7). If a determination is made that an untreated attribute value is remaining, the operating procedure returns to step S4 and variation amount calculation unit 13 selects one of untreated attribute values. Variation amount calculation unit 13 repeats step S4 to step S7 until no untreated attribute values is found and obtains variations of teacher data corresponding to all attribute values of the modality type selected in step S3.

When a determination is made in step S7 that no untreated variation value is remaining, variation amount calculation unit 13 obtains a representative value of variation between teacher data for the modality type selected in step S3 (step S8). In step S8, representative value determination unit 32 obtains variance of variations between teacher data corresponding to the respective attribute values obtained by repeating step S4 to step S7. Representative value determination unit 32 determines the obtained variance value as the representative value of variation between teacher data for the modality type selected in step S3.

Variation amount calculation unit 13 determines whether or not any untreated modality type is remaining (step S9). If a determination is made that an untreated modality type is remaining, the operating procedure returns to step S3 and variation amount calculation unit 13 selects one of untreated modality types. Variation amount calculation unit 13 repeats step S3 to step S9 until no untreated modality type is found. Through these steps, a representative value of variation between teacher data corresponding to each of all detection target modality types has been obtained.

Detection stage determination unit 14 makes a comparison between a representative value of variation between teacher data corresponding to each modality type and a threshold value Th(i) set to i^{th} stage (step S10). Detection stage determination unit 14 determines whether or not the representative value of variation between teacher data is greater than or equal to the threshold value Th(i) (step S11) and determines that a modality type of those of detection target with a representative value of variation between teacher data greater than or equal to the threshold value Th(i) to be detected by i^{th} detection processing unit 103-i (step S12). If there is a plurality of modality types to be detected by the i^{th} detection processing unit 103-i, detection stage determination unit 14 may configures the i^{th} detection processing unit 103-i to detect the modality types in parallel. Alternatively, detection stage determination unit 14 may configures the i^{th} detection processing unit 103-i to detect the plurality of modality types in series (cascade).

With respect to the modality type determined, by detection stage determination unit 14, to be detected by i^{th} detection processing unit 103-i, detection matrix generation unit 15 generates a detection matrix based on teacher data corresponding to the modality type (step S13). Detection matrix generation unit 15 generates a detection matrix according to the way how the attribute value of each modality type is to be detected by the i^{th} detection processing unit 103-i. Detection matrix generation unit 15 outputs the generated detection matrix so as to be available to detector 100. Otherwise, instead of generating and outputting a detection matrix or in addition to this, information identifying the modality type to be detected by the i^{th} detection processing unit 103-i may be displayed on an output device, such as a display.

Variation amount calculation unit 13 determines whether or not detection processing unit 103 is processed to the final stage (step S14). That is, variation amount calculation unit 13 determines whether or not the variable “i” has reached to N. If a determination is made that the processing has not reached to the final stage, variation amount calculation unit 13 increments the value of variable “i” by one (step S15) and the procedure returns to step S3. By repeating step S3 to step S15 until the final stage of detection processing unit 103 is processed, a determination is made as to which modality type is to be detected in which stage of detection processing unit 103. As the detection target modality type needs to be detected by at least one of the stages of detection processing unit 103, where there is any modality type not selected as the detection target of any stage from the first to final stages of detection processing unit 103-N, the modality type may be detected by the final stage detection processing unit 103-N.

Here, when a variation between teacher data is large, it may be deemed that a detector obtained by learning the teacher data may correctly discriminate the attribute value for each of a plurality of input data having a large variation. In this case, it is considered that the attribute value may be detected with a certain degree of resolution even when the resolution of the input data is low to a certain extent. That is, it is deemed that, as the variation between teacher data becomes large, a detector learned with the teacher data may detect the attribute value more accurately even by coarse detection (detection in low resolution). As described above, it may be considered that there is a certain degree of correlation between the variation between teacher data and the resolution for meaningful detection.

In the present embodiment, a representative value of variation between a plurality of teacher data with respect to each modality type is obtained and, based on the obtained representative value of variation between a plurality of teacher data, a determination is made as to in which stage of a plurality of detection stages of a detector to be configured each of modality type is to be detected. As described above, there is a certain degree of correlation between the variation between teacher data and the resolution for meaningful detection, an appropriate determination may be made as to which modality type is to be detected in which stage (which resolution) of the detection processing based on the variation between teacher data. In the present embodiment, the detector to be configured may perform efficient detection by combining a plurality of detection stages. Further, in the present embodiment, the modality type to be detected by each stage may be determined objectively based on the variation between teacher data.

In the present embodiment, a representative value of variation between teacher data is obtained after the resolution of the teacher data is converted to resolution in each detection processing. This allows the number of stages to be determined based on a variation between teacher data with a resolution to which input data are converted in the detector, and a determination may be made more accurately as to whether or not each modality type is detected by each stage. Further, in the present embodiment, a threshold value of each detection stage is set such that the higher the resolution in the detection processing, the higher the threshold value. When the threshold value is set in the manner described above, a detector in which a modality type that allows coarse detection is detected with low resolution may be configured since a modality type with a large variation between teacher data allows coarse detection.

Detector configuration apparatus 10 may be used for configuring a detector in the field of super-resolution. A detector in the field of super-resolution needs to have ability to correctly detect to which of multiple attribute values each of a plurality of modality types of input data correspond. Further, a high processing speed is also required. In the present embodiment, determination as to in which detection stage each modality type is to be detected, which has been manually and empirically performed by designers in the past, may be made automatically based on the variation between teacher data and a detector that performs efficient detection may be configured automatically.

When actually configuring a detector, detection by a detection processing unit 103 on the side of higher resolution (FIG. 2) may be omitted for some modality types according to required detection accuracy. For example, when the number of detection stages is three, an attribute value of a certain modality type may be detected, with required resolution, by detection processing to the second stage, detection in the third stage may be omitted. Detection processing unit 103 in a certain stage may receive a detection result from preceding detection processing unit 103 and perform detection by limiting the detection range. Correction, such as position correction, may be performed using a detection result of the preceding detection processing unit 103 and corrected data may be inputted to the subsequent detection processing unit 103. Further, in a case, for example, in which face detection is performed and attribute values of a plurality of modality types of the face are detected, information obtained from the face detection may be used for the detection of attributes of modality types.

When a modality type detected in a certain detection stage satisfies detection accuracy by the processing of the certain stage, the modality type may be excluded from a detection target list for a detection stage having a higher resolution than that of the certain detection stage. For example, with respect to a modality type determined in step S12 in FIG. 5 to be detected by i^{th} stage detection, detection stage determination unit 14 may perform a comparison between the variation between teacher data corresponding to the modality type and a predetermined threshold value. Detection stage determination unit 14 may exclude the modality type from the selection in step S3 if a representative value of variation of the teacher data is greater than or equal to the threshold value. This allows a modality type of those determined to be detected in a certain detection stage with a representative value of variation between teacher data greater than or equal to a predetermined threshold value to be excluded from a detection target list for a stage having higher resolution than that of the certain detection stage in which the modality type is determined to be detected.

A second embodiment of the present invention will now be described. The structure of the detector configuration apparatus of the present embodiment is identical to that of detector configuration apparatus 10 of the first embodiment shown in FIG. 1. The present embodiment differs from the first embodiment in that, when a plurality of modality types is determined to be the detection targets of i^{th} stage detection processing unit 103-i (FIG. 2), detection stage determination unit 14 determines if the plurality of modality types is detected in parallel, in series, or in combination of parallel and series. All other aspects are identical to those of the first embodiment.

When a plurality of modality types is present in step S12 in FIG. 5 in which determination is made that detection is performed in i^{th} stage detection processing 103-i, detection stage determination unit 14 obtains a correlation (similarity) between teacher data corresponding to the respective modality types. For example, when a determination is made that the modality type “face size” and the modality type “face orientation” are to be detected by the same stage, detection stage determination unit 14 obtains a correlation between teacher data corresponding to the “face size” and teacher data corresponding to the “face orientation”. Detection stage determination unit 14 performs threshold processing with a predetermined threshold value and determines the plurality of modality types to be detected in series when the similarity between teacher data corresponding to each of the plurality of modality types is high. Detection stage determination unit 14 determines the plurality of modality types to be detected in parallel when the similarity between teacher data corresponding to each of the plurality of modality types is low.

With respect to each of a plurality of modality types to be detected in the same detection stage, detection stage determination unit 14 obtains a representative value of variation between a plurality of teacher data corresponding to each attribute of each modality type. With respect to, for example, a modality type “face size”, detection stage determination unit 14 obtains a representative value of variation between a plurality of teacher data corresponding to each of 17 different face sizes. For example, detection stage determination unit 14 obtains an average value, mode value, or median value of pixel value with respect to each pixel of the teacher data as the representative value of variation. Further, with respect to “face orientation”, detection stage determination unit 14 obtains a representative value of variation between a plurality of teacher data corresponding to each of 4×9 different face orientations.

Detection stage determination unit 14 combines attribute values of different modality types and obtains a correlation between representative values of teacher data corresponding to the combined attribute values. For example, detection stage determination unit 14 may combine 17 different sizes of “face size” and 4×9 different face orientations of “face orientation” and obtains a correlation between representative values of teacher data corresponding to each combined attribute value. Detection stage determination unit 14 obtains a representative value of correlations obtained with respect to each combined attribute value. Detection stage determination unit 14 obtains, for example, an average value, mode value, median value, minimum value, maximum value, absolute minimum value, or absolute maximum value of correlations obtained with respect to each combined attribute value as the representative value. The obtained representative value is the correlation between teacher data corresponding to a plurality of modality types.

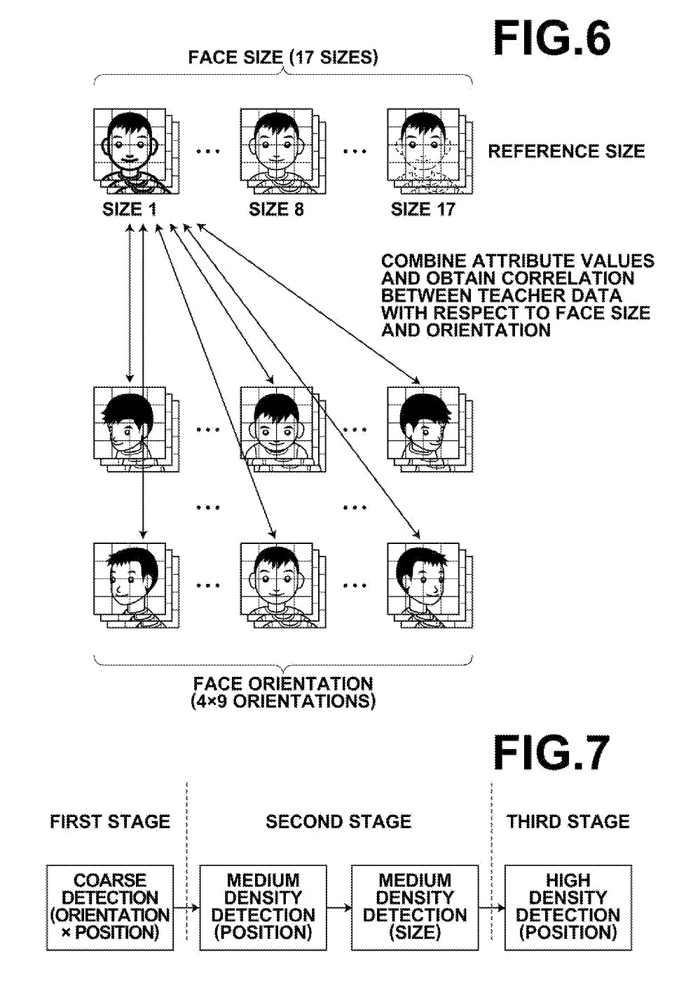

FIG. 6 illustrates calculation of correlation between teacher data. Here, “face size” and “face orientation” are considered as modality types. It is assumed that each of teacher data has already been enlarged or reduced to a reference size. With respect to “face size”, detection stage determination unit 14 obtains a representative value (representative image) from 100 teacher data per face size. Detection stage determination unit 14 obtains a representative image for each of 17 different face sizes. Likewise, with respect to “face orientation”, detection stage determination unit 14 obtains a representative image for each of 4×9 different face orientations.

Detection stage determination unit 14 generates combinations of a representative image of size 1 and a representative image of each of 4×9 different face orientations and obtains a correlation between each combination. Detection stage determination unit 14 calculates, for example, a correlation coefficient or cross-correlation between a representative image of size 1 and a representative image of each of 4×9 different face orientations. Likewise, with respect to remaining 16 different sizes, detection stage determination unit 14 calculates a correlation coefficient or cross-correlation between a representative image of each size and a representative image of each of 4×9 different face orientations. Detection stage determination unit 14 obtains an average value of the obtained 17×(4×9) correlation coefficients or cross-correlations as the representative value.

Detection stage determination unit 14 performs a threshold judgment on the obtained representative correlation value. If the representative correlation value is greater than or equal to the threshold value, that is, when the representative correlation value is close to 1 and the degree of similarity between teacher data corresponding to the two modality types is high, detection stage determination unit 14 determines that the two modality types are to be detected in series. In this case, for example, detection will be performed in i^{th} stage detection processing unit 103-i as to which of 4×9 different face orientations the “face orientation” belongs, and then to which of 17 different face sizes the “face size” belongs. If the representative correlation value is smaller than the threshold value, that is, when the representative correlation value is far from 1 and the degree of similarity between teacher data corresponding to the two modality types is low, detection stage determination unit 14 determines that the two modality types are to be detected in parallel. In this case, for example, a total of 17×(4×9) combinations of 17 kinds of “face size” and 4×9 kinds of “face orientation” will be detected in i^{th} stage detection processing unit 103-i.

In the present embodiment, a correlation between teacher data corresponding to a plurality of modality types to be detected in the same detection stage is obtained and a determination is made that the plurality of modality types to be detected in the same detection stage is to be detected in series if the obtained correlation is greater than or equal to a threshold value. A high correlation between modality types implies that the teacher data corresponding to the modality types are similar and when, for example, face size and face orientation are to be detected in the same stage, the face orientation can be detected even when the face size can not be identified. In the present embodiment, determination is made as to whether or not the modality types can be detected in series based on the correlation of teacher data between the modality types. When trying to detect, for example, face size and face orientation in parallel, 17×(4×9) detection operations are required. Serial detection of modality types, which can be detected in series, may reduce the number of combinations required to be detected, for example, to 17+(4×9), thereby allowing the detector 100 to be configured to perform more efficient detection.

FIG. 7 illustrates an example configuration of a detector. Now, for example, three modality types of “face size”, “face orientation”, and “face position” are considered. Further, three detection stages of “coarse detection (first stage)”, “medium density detection (second stage)”, and “high density detection (third stage)” are considered here. It is assumed that detector configuration apparatus 10 has decided that “face orientation” and “face position” are to be detected by the coarse detection, “face size” and “face position” are to be detected by medium density detection, and “face position” is to be detected by the high density detection. The “face orientation” is excluded from a detection target list for the medium density detection onward on the assumption that predetermined detection accuracy may be obtained by the coarse detection. Further, the “face size” is excluded from a detection target list for the high density detection on the assumption that predetermined detection accuracy may be obtained by the medium density detection.

The “face orientation” and “face position” to be detected by the coarse detection have a low correlation between teacher data and they are detected in parallel in the coarse detection. In the mean time, “face size” and “face position” to be detected by the medium density detection have a high correlation between teacher data and they are detected in series in the medium density detection. In a case where a plurality of modality types is to be detected in series in a certain stage, a determination as to which of the modality types is to be detected first may be made based on a representative value of variation of teacher data corresponding to each of the modality types. For example, when the representative value of variation of teacher data corresponding to “face position” is greater than the representative value of variation of teacher data corresponding to “face size”, detection stage determination unit 14 determines that “face position” is detected first and then “face size” in the medium density detection.

When configuring a detector in the manner as illustrated in FIG. 7, the detector may be configured to detect “face position” and “face size” in series in the medium density detection and thereby processing burden may be reduced in comparison with the case in which detector is configured to detect them in parallel in the medium density detection. Further, when detecting “face position” in the medium density detection, the detection range may be narrowed down using a detection result of position detected for “face position” in the coarse detection. Also, for the detection of “face position” in the high density detection, the detection range may be narrowed down using a detection result of position detected for “face position” in the medium density detection. Efficient detection becomes possible by combining detection operations with a plurality of resolutions and narrowing down the position detection range.

In each embodiment described above, the description has been made of a case in which object data 101 (FIG. 2) and teacher data are image data, but not limited to this. Object data 101 and teacher data may be any multidimensional data which can be represented as vector data. Further, the object is not limited to a human face.

In each embodiment described above, a variation between teacher data is obtained after converting the resolution of the teacher data to that in each detection stage, but not limited to this. For example, the variation between teacher data may be obtained without converting the dimensionality of vector data representing teacher data or after converting dimensionalities of vector data representing teacher data to a predetermined dimensionality. In these cases, variation amount calculation unit 13 may obtain only one variation between teacher data instead of obtaining a variation between teacher data with respect to each stage, that is, instead of obtaining a number of variations between teacher data corresponding to the number of detection stages.

In the case described above, detection stage determination unit 14 may determine a modality type of the plurality of modality types having a representative value of variation determined by representative value determination unit 32 greater than or equal to a threshold value Th(1) set to a first stage when a plurality of detection stages is arranged in ascending order of resolution to be detected in the first detection stage onward. Further, detection stage determination unit 14 may determine that a modality type of the plurality of modality types with a representative value of variation greater than or equal to a threshold value Th(i+1)(i is an integer in the range from 1 to the number of stages minus 1) set to (i+1)^{th} stage and smaller than a threshold value Th(i) set to i^{th} stage to be detected in the (i+1)^{th} detection stage onward. Here, it is assumed that threshold values corresponding to the respective stages are set such that Th(i)>Th(i+1) is satisfied in which “i” represents any arbitrary stage.

In the second embodiment, only one detection stage may be provided. In this case, detector configuration apparatus 10 configures the detector such that a modality type of a plurality of detection target modality types with a high correlation between teacher data is to be detected in parallel while a modality type of a plurality of detection target modality types with a low correlation is to be detected in series. Serial detection of modality types, which can be detected in series, may reduce the processing time in comparison with the case in which the modality types are detected in parallel. Further, parallel detection of modality types that can not be detected in series may reduce the chance of erroneous detection. That is, an appropriate combination of serial detection and parallel detection allows the processing time to be reduced without degrading detection accuracy. Provision of only one detection stage in the second embodiment may provide an advantageous effect that a determination as to which modality type is to be detected in parallel and which modality type is to be detected in series may be made using an objective criterion for judgment based on teacher data.

So far the present invention has been described based on preferred embodiments, but the detector configuration apparatus, method, and program of the present invention are not limited to the embodiments described above, and it should be understood that various modifications and changes made to the embodiments described above fall within the scope of the present invention.

What is claimed is:

1. A detector configuration apparatus, comprising:
a variation amount calculation unit for obtaining, based on a plurality of teacher data corresponding to each of a plurality of modality types, a representative value of variation between the plurality of teacher data with respect to each modality type, the teacher data being used for training a detector that detects, through a plurality of detection stages with different resolutions, to which of a plurality of attribute values an attribute of an object included in input data corresponds with respect to each of a plurality of modality types; and
a detection stage determination unit for determining in which stage of the plurality of detection stages each modality type is to be detected based on the representative value of variation between the teacher data obtained by the variation amount calculation unit.

2. The detector configuration apparatus of claim 1, wherein the variation amount calculation unit is a unit that obtains a variation between a plurality of teacher data corresponding to each attribute to be detected in each modality type, and obtains the representative value of variation for each modality type based on the obtained variation between the teacher data corresponding to each attribute.

3. The detector configuration apparatus of claim 1, wherein the variation amount calculation unit comprises:
an inter-data variation calculation unit for obtaining a variation between a plurality of teacher data corresponding to each attribute value; and
a representative value determination unit for determining the representative value of variation based on the variation between the teacher data corresponding to each attribute value obtained by the inter-data variation calculation unit.

4. The detector configuration apparatus of claim 3, wherein the representative value determination unit is a unit that obtains an average value of the variation between the teacher data corresponding to each attribute value and determines the obtained average value to be the representative value of variation.

5. The detector configuration apparatus of claim 3, wherein the inter-data variation calculation unit is a unit that obtains, with respect to a plurality of dimension positions, a data distribution of elements of each of the plurality of teacher data at the same dimension position when the teacher data are viewed as vector data, obtains a data variation for each dimension position based on the obtained data distribution, and obtains the variation between the teacher data based on the data variation obtained for each dimension position.

6. The detector configuration apparatus of claim 5, wherein the inter-data variation calculation unit is a unit that determines a variation of data variation obtained for each dimension position as the variation of the teacher data corresponding to the attribute value.

7. The detector configuration apparatus of claim 5, wherein the inter-data variation calculation unit is a unit that converts resolution of the plurality of teacher data to resolution corresponding to each of the plurality of detection stages and obtains, for each detection stage, a data distribution of vector data at the same dimension position representing each of the teacher data having converted resolution corresponding to each detection stage.

8. The detector configuration apparatus of claim 7, wherein the inter-data variation calculation unit is a unit that obtains, for each detection stage, a variation between the teacher data corresponding to each attribute value, and the representative value determination unit is a unit that determines a representative value of variation for each detection stage based on the variation between the teacher data corresponding to each attribute value with respect to each detection stage obtained by the inter-data variation calculation unit.

9. The detector configuration apparatus of claim 8, wherein the detection stage determination unit is a unit that compares a threshold value set to each detection stage with the representative value of variation determined with respect to each modality for each detection stage by the representative value determination unit and determines a modality type having a representative value of variation greater than or equal to a threshold value of a certain one of the detection stages to be detected in the certain one of the detection stages.

10. The detector configuration apparatus of claim 5, wherein the inter-data variation calculation unit is a unit that obtains the data distribution at the same dimension position after converting dimensionalities of vector data representing the plurality of teacher data to a predetermined dimensionality.

11. The detector configuration apparatus of claim 10, wherein the detection stage determination unit is a unit that determines any of the plurality of modality types having a representative value of variation determined by the representative value determination unit greater than or equal to a threshold value Th(1) set to a first stage when the plurality of detection stages is arranged in ascending order of resolution to be detected in the first detection stage onward and any of the plurality of modality types having a representative value of variation determined by the representative value determination unit greater than or equal to a threshold value Th(i+1) (i is an integer in the range from 1 to the number of stages minus 1) set to (i+1)^{th} stage and smaller than a threshold value Th(i) set to i^{th} stage to be detected in the (i+1)^{th} stage onward.

12. The detector configuration apparatus of claim 1, wherein the detection stage determination unit is a unit that compares a representative value of variation of teacher data corresponding to a modality type determined to be detected in a certain detection stage with a predetermined threshold value and excludes the modality type from a detection target list for a detection stage having higher resolution than that of the certain detection stage when the representative value of variation of teacher data is greater than or equal to the predetermined threshold value.

13. The detector configuration apparatus of claim 1, wherein the detection stage determination unit is a unit that, when a determination is made that a plurality of modality types is to be detected in one detection stage, obtains a correlation between teacher data corresponding to the plurality of modality types to be detected in the one detection stage and, when the obtained correlation is greater than or equal to a predetermined threshold value, determines that the plurality of modalities to be detected in the one detection stage is to be detected in series.

14. The detector configuration apparatus of claim 13, wherein the detection stage determination unit is a unit that obtains, with respect to each of the plurality of modality types to be detected in the one detection stage, a representative value of teacher data from a plurality of teacher data corresponding to each attribute value, combines attribute values of a plurality of modality types, obtains a correlation between representative values of teacher data corresponding to the combined attribute values, obtains a representative value of correlations obtained with respect to each combination of attributes, and determines the obtained representative correlation value as the correlation between teacher data corresponding to the plurality of modality types.

15. The detector configuration apparatus of claim 1, further comprising a detection matrix generation unit for generating a detection matrix with respect to each modality based on the teacher data.

16. A method for configuring a detector that detects, through a plurality of detection stages with different resolutions, to which of a plurality of attribute values an attribute of an object included in input data corresponds with respect to each of a plurality of modality types, the method comprising the steps of:
obtaining, based on a plurality of teacher data corresponding to each modality type used for training the detector, a representative value of variation between the plurality of teacher data with respect to each modality type; and
determining in which stage of the plurality of detection stages each modality type is to be detected based on the obtained representative value of variation between the teacher data.

17. A computer readable recording medium on which is recorded a program for causing a computer to perform processing for configuring a detector that detects, through a plurality of detection stages with different resolutions, to which of a plurality of attribute values an attribute of an object included in input data corresponds with respect to each of a plurality of modality types, the program causing a computer to perform the steps of:
obtaining, based on a plurality of teacher data corresponding to each modality type used for training the detector, a representative value of variation between the plurality of teacher data with respect to each modality type; and
determining in which stage of the plurality of detection stages each modality type is to be detected based on the obtained representative value of variation between the teacher data.
